(19) United States
(12) Patent Application Publication
(10) Pub. No.: US 2013/0312468 A1
(43) Pub. Date: Nov. 28, 2013

(54) SINGLE KEY, INTERCHANGEABLE CYLINDER LOCK

(71) Applicant: BRIDGESTONE CAPITAL, LLC., Franklin, WI (US)

(72) Inventors: Jerry William READ, Oak Creek, WI (US); James R. HEATH, Raymore, MO (US)

(73) Assignee: BRIDGESTONE CAPITAL, LLC., Franklin, WI (US)

(21) Appl. No.: 13/900,865

(22) Filed: May 23, 2013

Related U.S. Application Data
(60) Provisional application No. 61/651,344, filed on May 24, 2012.

(51) Int. Cl. E05B 27/00

(52) U.S. Cl. CPC E05B 27/005
USPC 70/493

(57) ABSTRACT

A re-keyable lock provides a cylinder that may be removed from the cylinder housing when the cylinder is in the unlocked state allowing the lock to be re-keyed with a standard key. A blocking element may be removed by a user having access to the keyhole and otherwise serves to retain the cylinder in the cylinder housing during the unlocked state.

### CROSS-REFERENCE TO RELATED APPLICATIONS

This application claims the benefit of U.S. provisional application 61/651,344 filed May 24, 2012 and hereby incorporated by reference.

### FIELD OF THE INVENTION

The present invention relates to key activated locks and in particular to a lock that may be “re-keyed” by replacement of the lock cylinder without the removal of the lock from the door.

### BACKGROUND OF THE INVENTION

Key activated locks may have a rotatable plug held against rotation within a cylinder by a set of tumblers that extend across an interface between the rotatable plug and the cylinder when the key is removed. When a key is inserted, the tumblers are aligned with the interface and the plug may rotate to actuate a lock mechanism, such as a bolt, that may be retracted or allowed to retract after rotation of the lock cylinder.

In many commercial environments, it is necessary to frequently change the keys associated with a lock, for example, upon changeover of personnel or the loss of a key. This “re-keying” may be done by replacing the tumblers of the plug of the lock or the entire cylinder. Disassembly of the lock to remove the cylinder requires access to the “inside” of the door and/or the bolt, this requirement preventing defeat of the lock by removal of the cylinder from the “outside” when the door is locked and closed.

Re-keying operations are relatively time-consuming and may require the services of a skilled professional locksmith. Accordingly, it is also known to use “interchangeable core” locks whose cylinders may be readily replaced from the outside of the door and when the door is closed without disassembly of the lock. Removal of the cylinder in such circumstances is possible without compromising the security provided by the lock by permitting removal of the cylinder only by a user having a special “control key” different from the normal keys used with the lock. Rotation of the control key retracts tabs or other features on the cylinder that normally hold the cylinder in the cylinder housing, allowing the cylinder to be removed and replaced with a different cylinder. Turning the cylinder with a standard operator key does not affect these locking tabs or features.

### SUMMARY OF THE INVENTION

The present invention provides an interchangeable core lock that does not require a separate control key but that permits re-keying and cylinder replacement using only the standard operator keys used with the lock. The invention allows the cylinder to be removed only when the lock is in the unlocked state thus preventing individuals without keys from changing or defeating the lock. Inadvertent removal of the core is prevented by a low-security secondary locking feature that may be released from the “outside” of the door with common tools or by hand. The invention provides simple re-keying without the complexity or cost of a standard interchangeable core cylinder.

Specifically, in one embodiment, the invention provides a replaceable cylinder lock having a cylinder housing with a chamber holding a cylinder, the cylinder providing a plug having a keyhole for receiving a key therein and tumbler pins activated by the key to allow rotation of the plug with respect to the cylinder between a lock and unlock position. A bolt communicating with the plug may move between a lock state for locking a door when the plug is in the lock position and an unlocked state for unlocking the door when the plug is in the unlock position. An interlock, communicating with the plug to move therewith, retains the plug and cylinder within the cylinder housing only when the plug is in the lock position and not when the plug is in the unlock position.

It is thus a feature of at least one embodiment of the invention to allow “rekeying” of a lock by replacement of the lock cylinder without the need for a special key different from the normal keys used with the lock.

The replaceable cylinder lock may include a blocking element positionable by a user having access to the keyhole in either of a first position blocking the cylinder within the chamber and a second position not blocking the cylinder within the chamber.

It is thus a feature of at least one embodiment of the invention to prevent inadvertent dislodgment of the cylinder when in the unlocked state during normal use.

The blocking element may be positionable by the user without use of the key.

It is thus a feature of at least one embodiment of the invention to provide a relatively simple blocking element design recognizing that high-security is not required for this element.

The blocking element may be an escutcheon positionable about the keyhole to retain the cylinder within the chamber by capturing a portion of the cylinder.

It is thus a feature of at least one embodiment of the invention to implement the blocking function in the existing escutcheon element.

The escutcheon maybe retained on the cylinder housing by a threaded set screw having a head receiving a tool excluding a standard slotted screw driver.

It is thus a feature at least one embodiment of the invention to prevent casual removing of the blocking element while allowing it to be removed with readily available commodity tools.

The interlock may be a tab extending rearward from the plug to engage and disengage a surface of the cylinder housing with rotation of the plug.

It is thus a feature at least one embodiment of the invention to provide an extremely simple mechanism for retaining the cylinder within the cylinder housing that may make use of the security provided by the pre-existing tumbler pins.

The surface of the cylinder housing engaged by the tab may be a plate having an opening permitting axial passage of the tab with the plug in a first rotated state and blocking axial passage of the tab of the plug in the second state.

It is thus a feature of at least one embodiment of the invention to use a mechanically simple interlocking mechanism protected from access by the plug itself.

The plate may be a steel plate fitting within a brass cylinder housing.

It is thus a feature of at least one embodiment of the invention to permit manufacture of the cylinder housing from easily machined material while providing for high strength against forcible extraction of the plug, for example, by a slide hammer.

The replaceable cylinder lock may include a detent retaining the bolt against locking when the cylinder is removed from the cylinder housing.

It is thus a feature of at least one embodiment of the invention to prevent misalignment of internal elements of the lock during the cylinder replacement.

The detent may provide for a positive locking of the bolt in the unlock position when the cylinder is removed. In one example, the detent may provide a spring-actuated pawl moved by insertion of the cylinder within the cavity housing away from interference with a rotating member rotated by the plug.

It is thus a feature of at least one embodiment of the invention to positively unlock the lock during cylinder replacement by sensing the presence or absence of the cylinder.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a fragmentary perspective view of a door lock assembly using the lock of the present invention;

FIG. 2 is an exploded perspective view of one embodiment of the lock of the present invention showing the lock cylinder fitting within a cylinder housing as held by a primary and secondary locking feature;

FIG. 3 is a fragmentary cross-section of the cylinder housing showing the primary locking feature that may retain the cylinder within the cylinder housing;

FIG. 4a is a figure similar to FIG. 3 showing a passage of a rearwardly extending T-tab on the lock cylinder through a corresponding retention slot in cylinder housing when the cylinder is in the unlocked state;

FIG. 4b is a figure similar to FIG. 4a showing movement of the T-tab to lock within the retention slot when the cylinder is in the lock state;

FIG. 5 is an elevational cross-section taken along line 5-5 of FIG. 1 (with the retention slot removed for clarity) showing engagement of the T-tab with a transition cam communicating with the locking mechanism with an anti-rotation pawl retracting with insertion of the lock cylinder into the cylinder housing and further showing an escutcheon providing the secondary locking feature for the lock cylinder;

FIG. 6 is a front elevational view of the transition cam showing engagement of the anti-rotation pawl when the cylinder is removed;

FIG. 7 is a fragmentary cross-section similar to that of FIG. 5 showing the retention slot integrally formed with the cylinder housing;

FIG. 8 is a figure similar to that of FIG. 7 showing the retention slot as an insertion into the lock housing; and

FIG. 9 is a flowchart describing the steps of replacing the cylinder of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof

### DETAILED DESCRIPTION OF THE PREFERRED EMBODIMENTS

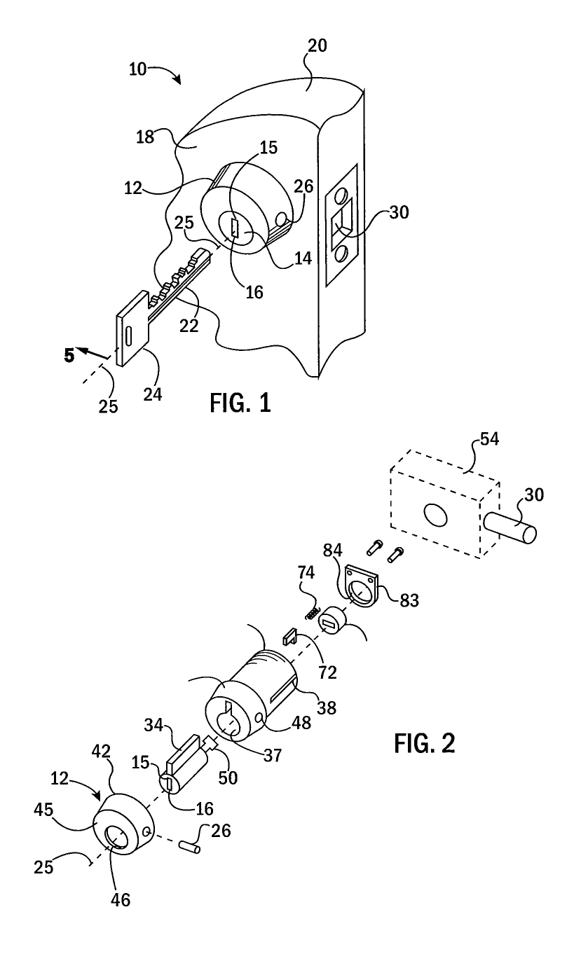

Referring now to FIG. 1, a lock 10 may provide for an escutcheon 12 exposing a keyhole 16 of a cylinder 14 on an outside surface 18 of the door 20. The keyhole 16 may allow for insertion of the blade 22 of a key 24 into the keyhole 16 along an insertion axis 25 generally perpendicular to the plane of the outside of the door 20. As is understood in the art, the blade 22 includes a set of axially spaced ridges whose heights uniquely position tumblers within the lock 10 for rotation of an inner portion of the cylinder 14 termed the plug 15. Rotation of the plug 15 of the cylinder 14 may then operate an internal locking mechanism to extend or retract (or permit extension or retraction) of a bolt 30 that may be received within an aperture of the strike plate (not shown) on the door jam.

Referring to FIGS. 1 and 2, the cylinder 14 may provide a cylindrical outer portion having an upwardly extending tumbler tower 34 holding tumbler pins, drivers and springs as is generally understood in the art. The cylinder 14 may be received in a corresponding chamber 37 of a cylinder housing 38 having a circular bore for receiving the cylindrical outer portion of the cylinder 14 and a slot for receiving the tumbler tower 34. The cylinder housing 38 is retained and fixed in the door 20, for example, by means of a outer threaded surface 40 (for mortise lock cylinder) or by machine screws passing through the door (for a rim lock cylinder) according to methods well known in the art.

When the cylinder 14 is fitted within the chamber 37 of the cylinder housing 38, the cylinder 14 may be retained by a secondary retaining element formed by the escutcheon 12 fitting over the end of the cylinder housing 38. Generally the escutcheon 12 has a frustoconical skirt 42 extending from a planar base 45, the latter providing a circular opening 46 that provides access to keyhole 16 but prevents removal of the lock cylinder 14, for example, by interference between the base 45 of the escutcheon 12 outside of the opening 46 and the tumbler tower 34. The escutcheon 12 may be attached to the cylinder housing 38 at a corresponding frustoconical supporting surface 44 on the front of the cylinder housing 38. Specifically, frustoconical skirt 42 of the escutcheon 12 may be locked to the supporting surface 44 on the front of the cylinder housing 38 using a set screw 26 that may pass through the skirt 42 to engage a corresponding dimple 48 in the supporting surface 44 of the cylinder housing 38. As will be explained more fully below, the escutcheon 12 provides relatively low security retention of the cylinder 14 within the cylinder housing 38 that prevents the cylinder 14 from being inadvertently removed so long as the escutcheon 12 is in place. Nevertheless, the escutcheon 12 can be removed with simple tools (for example a hex wrench or Torx™ wrench) applied to the set screw 26 from the outside (e.g. the insecure side) of the door 20.

As is understood in the art, the cylinder 14 includes a plug 15 communicating with the keyhole 16 that may rotate with respect to the remainder of the cylinder 14 when a proper key 24 is inserted in the keyhole 16 and the tumblers appropriately aligned. This plug 15 communicates with a T-tab 50 projecting axially rearward from the cylinder 14 to rotate with rotation of the plug 15 of the cylinder 14. The T-tab may be received by a transition cam 52 held in the rear of the cylinder housing 38 which may in turn communicate with a locking mechanism 54 operating the bolt 30, as described above, based on the rotational position of the T-tab 50 according to techniques generally understood in the art.

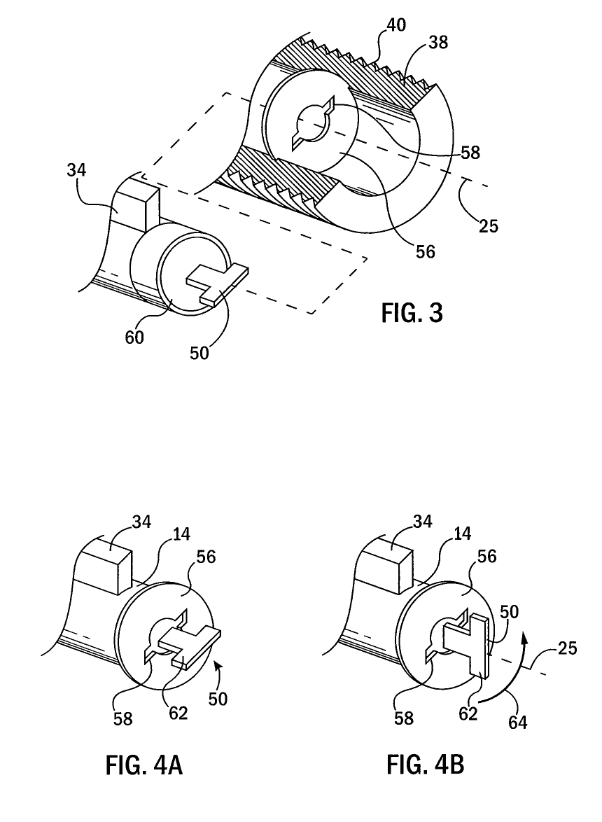

Referring now to FIG. 3, the cylinder housing 38 may support, at its rear, a stop wall 56 having a retention slot 58 through which the T-tab 50 may pass when the plug 15 of the cylinder 60 is in an unlocked state corresponding to its position when a proper key has been inserted and rotated to unlock the lock 10. Referring to FIG. 4a, in this regard, the T-tab 50 provides a blade 62 having radially extending tabs lying within a horizontal plane when the lock 10 is unlocked and that may fit through corresponding horizontally extending portions of the retention slot 58 in this configuration. Referring to FIG. 4b, rotation of the plug 15 of the cylinder 14 by 90° (or other predetermined angle as indicated by arrow 64) to a locked state, moves the blade 62 to a vertical position perpendicular to the horizontal extension of the slot 58 preventing subsequent removal of the cylinder 14 along axis 25 while the cylinder 14 is in this locked state. The interengagement of the T-tab 50 and the retention slot 58 provides a primary locking mechanism holding the cylinder 14 in the cylinder housing 38. Generally, it will be understood, therefore, that retention or release of the cylinder 14 is provided by the same key 24 that operates the bolt 30 eliminating the need for a separate control key or the complexity of an interchangeable core cylinder mechanism. The interengagement of the T-tab 50 and the retention slot 58 as operated by the operator key 24 provides the same security against cylinder removal as that required for the unlocking of the door 20. Only when the cylinder 14 is in the unlocked state (implicitly at a time when there is no motivation to defeat the lock by removing its cylinder) can the lock cylinder 14 be removed. Accidental or casual removal of the lock cylinder 14 in this unlocked state is prevented by escutcheon 12 providing the secondary locking mechanism described above.

The lock 10 thereby provides a high-security cylinder retention element in the form of the interengagement of the T-tab 50 and the retention slot 58 coupled with a low security retention feature in the form of the interference between the escutcheon 12 as retained by set screw 26 and the tumbler tower 34 or other projecting feature of the non-rotating portions of the cylinder 14. Importantly, the low security retention feature does not require exclusive distribution of an unlocking feature such as a control key but can be operated with commonly available tools.

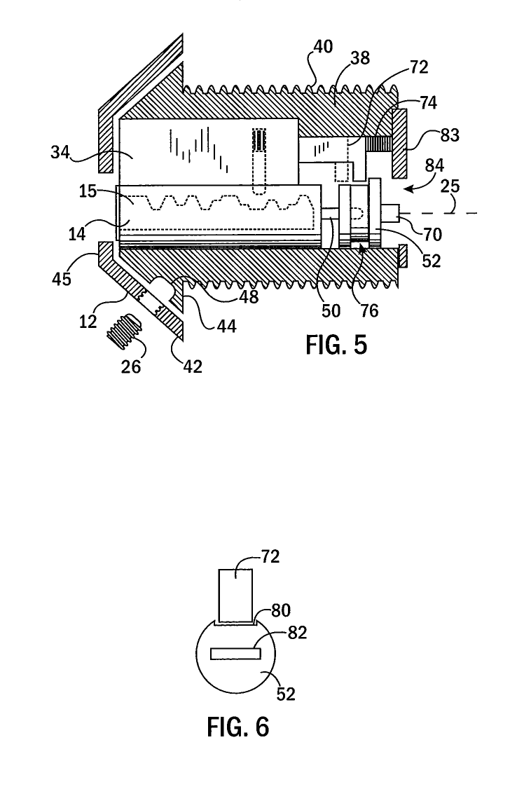

Referring now to FIGS. 5 and 6, blade 62 of the T-tab 50, after extending through the retention slot 58, may engage a transition cam 52 with the blade 62 fitting in a corresponding slot 82 in a front surface of that transition cam 52 to link the two elements with respect to rotation about axis 25. The transition cam 52 is supported within a bore of the cylinder housing 38 to rotate generally along insertion axis 25 with rotation of the plug 15 of the cylinder 14 (and the blade 62 of the T-tab 50) and communicate that rotation to a standard lock mechanism interface feature 70 communicating with standard lock mechanisms 54. It will be understood that the interface feature 70 may be freely adjusted to be compatible with the requirements of different standard lock mechanisms 54.

Free rotation of the cam 52 when the cylinder 14 is removed is prevented by means of an anti-rotation pawl 72 that is normally pushed rearward by contact between the anti-rotation pawl and a rear edge of the tumbler tower 34 against a countervailing biasing of a spring 74. When the cylinder 14 is in place within the cylinder housing 38, the anti-rotation pawl 72 aligns with a groove 76 of the transition cam 52 allowing free rotation of the transition cam 52.

Referring specifically to FIG. 6, when the cylinder 14 is removed, however, the anti-rotation pawl moves forward to engage a flat 80 on an outer periphery of the transition cam 52 preventing rotation of the transition cam 52 from its unlocked orientation, the orientation where the slot 82 is generally in a horizontal orientation.

Referring to FIGS. 2 and 5, the transition cam, anti-rotation pawl 72 and spring 74 are retained in the cylinder housing 38 by a cover plate 83 having an opening 84 allowing rearward exposure of the interface feature 70.

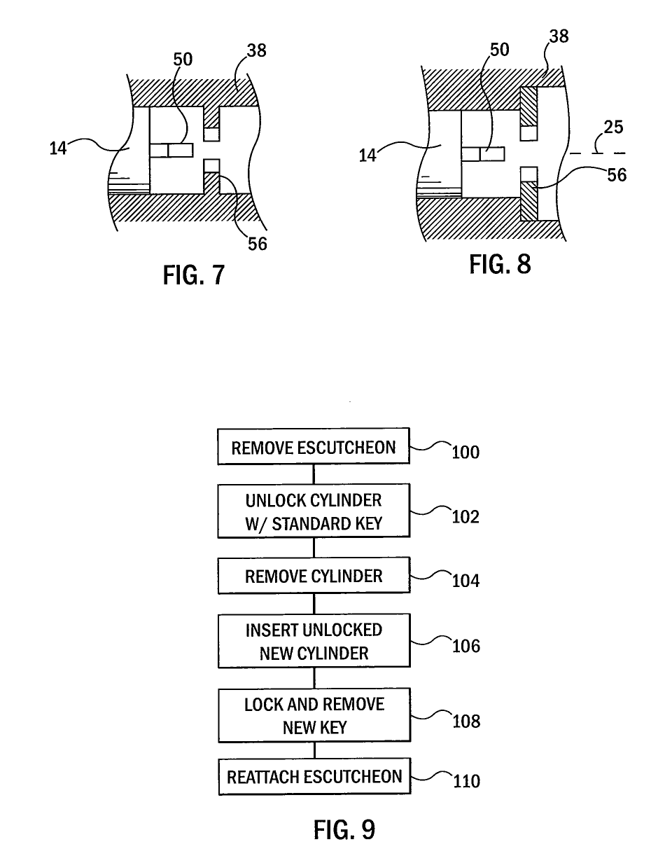

Referring now to FIG. 7, the retention stop wall 56 may be integrally machined into the cylinder housing 38 or, as shown in FIG. 8, may be an inserted disk pressed to fit against a ridge formed in the cylinder housing 38 preventing its forward or rotary motion. This latter configuration, for example, allows the stop wall 56 to be a high-strength steel material, for example, inserted into a readily machined brass cylinder housing 38.

Referring now to FIG. 9, replacement of the cylinder for re-keying may be accomplished by removing the escutcheon 12 as indicated by process block 100 and then unlocking the cylinder 14 with an operator key 24 as indicated by process block 102. The old cylinder 14 may then be removed as indicated by process block 104 and a new cylinder 14 inserted in the place of the old cylinder 14 as indicated by process block 106, the new cylinder 14 being in an unlocked state to match the orientation of the transition cam 52. At process block 108, the new cylinder may be locked, locking the new cylinder 14 into place as shown in FIG. 4b, and the key removed after which the escutcheon 12 may be replaced as indicated by process block 110.

Certain terminology is used herein for purposes of reference only, and thus is not intended to be limiting. For example, the terms such as “inside”, “outside”, “upper”, “lower”, “above”, and “below” refer to directions in the drawings to which reference is made. Terms such as “left”, “right”, “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence, or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A replaceable cylinder lock comprising:
a cylinder housing providing a chamber holding a cylinder, the cylinder providing a plug having a keyhole for receiving a key therein and tumbler pins activated by the key to allow rotation of the plug with respect to the cylinder between a lock and unlock position;
a bolt communicating with the plug to move between a lock state for locking a door when the plug is in the lock position and an unlocked state for unlocking the door when the plug is in the unlock position; and
an interlock communicating with the plug to move therewith, the interlock retaining the plug and cylinder within the cylinder housing only when the plug is in the lock position and not when the plug is in the unlock position.

2. The replaceable cylinder block of claim 1 including a blocking element positionable by a user having access to the keyhole in either of a first position blocking the cylinder within the chamber and a second position not blocking the cylinder within the chamber.

3. The replaceable cylinder block of claim 2 wherein the blocking element is positionable by the user without use of the key.

4. The replaceable cylinder block of claim 3 wherein the blocking element is an escutcheon positionable about the keyhole to retain the cylinder within the chamber by capturing a portion of the cylinder.

5. The replaceable cylinder block of claim 4 wherein the escutcheon is retained on the cylinder housing by a threaded set screw having a head receiving a tool excluding a standard slotted screw driver.

6. The replaceable cylinder block of claim 1 wherein the interlock is a tab extending rearward from the plug to engage and disengage a surface of the cylinder housing with rotation of the plug.

7. The replaceable cylinder block of claim 6 wherein the surface of the cylinder housing engaged by the tab is a plate having an opening permitting axial passage of the tab with the plug in the unlocked state and blocking axial passage of the tab of the plug in the locked state.

8. The replaceable cylinder block of claim 7 wherein the plate is a steel plate fitting within a brass cylinder housing.

9. The replaceable cylinder block of claim 1 further including a detent retaining the bolt against locking when the cylinder is removed from the cylinder housing.

10. The replaceable cylinder block of claim 9 wherein the detent provides for a positive locking of the bolt in the unlock position when the cylinder is removed.

11. The replaceable cylinder block of claim 10 wherein the detent provides a spring actuated pawl moved by insertion of the cylinder within the cylinder housing away from interference with a rotating member rotated by the plug.

12. A method of rekeying a replaceable cylinder lock in a door of a type having:
a cylinder housing providing a chamber holding a cylinder, the cylinder providing a plug having a keyhole for receiving a key therein and tumbler pins activated by the key to allow rotation of the plug with respect to the cylinder between a lock and unlock position;
a bolt communicating with the plug to move between a lock state for locking a door when the plug is in the lock position and an unlocked state for unlocking the door when the plug is in the unlock position;
an interlock communicating with the plug to move therewith, the interlock retaining the plug and cylinder within the cylinder housing only when the plug is in the lock position and not when the plug is in the unlock position; and
a blocking element positionable by a user having access to the keyhole in either of a first position blocking the cylinder within the chamber and a second position not blocking the cylinder within the chamber, the method comprising the steps of:
(a) from a keyhole side of the door, removing the blocking element;
(b) inserting a key in the keyhole and moving the plug to the unlocked state;
(c) removing the cylinder from the cylinder housing;
(d) inserting a new key in a new cylinder and moving the new cylinder to the unlocked state;
(e) inserting the new cylinder in the cylinder housing; and
(f) reinstalling the blocking element.
